(19) United States
(12) Patent Application Publication
(10) Pub. No.: US 2006/0264073 A1
(43) Pub. Date: Nov. 23, 2006

(54) Planar heat dissipating device

(76) Inventors: Chien-Yuh Yang, Tao-Yuan Hsien (TW); Chun-Ta Yeh, Chang-Hua Hsien (TW); Wei-Chi Liu, Nan-Tou Hsien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/436,204

(22) Filed: May 16, 2006

(30) Foreign Application Priority Data
May 18, 2005 (TW) 094116093
Mar. 27, 2006 (TW) 095110517

(51) Int. Cl. H01R 12/00

(52) U.S. Cl. 439/72

(57) ABSTRACT

A planar heat dissipating device includes: a planar housing defining a planar inner space therein; and a partitioning unit dividing the inner space into a plurality of upper fluid channels and a plurality of lower fluid channels that cross the upper fluid channels. Each of the upper fluid channels is in fluid communication with at least one of the lower fluid channels at an intersection therebetween.

### CROSS-REFERENCE TO RELATED APPLICATION

This application claims priority of Taiwanese application no. 094116093, filed on May 18, 2005, and Taiwanese application no. 095110517, filed on Mar. 27, 2006.

### BACKGROUND OF THE INVENTION

1. Field of the Invention

This invention relates to a planar heat dissipating device, more particularly to a planar heat dissipating device having a planar inner space divided into a plurality of crossed upper and lower fluid channels by a partitioning unit.

2. Description of the Related Art

FIGS. 1 and 2 illustrate a conventional planar heat dissipating device 1 for dissipating heat from an electronic component 17, such as a CPU. Working fluid is driven by a circulating pump 18 to circulate through the heat dissipating device 1 and a cooling device 19. The heat dissipating device 1 includes: a planar housing having a lower housing half 11 and an upper housing half 12 that complements the lower housing half 11 to form an inner space therebetween; and a partitioning unit disposed in the inner space in the planar housing and having parallel lower ribs 14 and upper lower ribs (not shown) so as to divide the inner space in the planar housing into a plurality of parallel straight fluid channels 15. The upper housing half 12 is formed with a fluid inlet 161 and a fluid outlet 162 which are in fluid communication with the inner space in the planar housing.

FIG. 3 illustrates another conventional heat dissipating device 2 that includes: a planar housing having a lower housing half 21 and an upper housing half 22 that complements the lower housing half 21 to define an inner space therebetween; and a partitioning unit disposed in the inner space in the planar housing and having upper and lower central ribs 24, and upper and lower U-shaped ribs 26 so as to divide the inner space in the planar housing into parallel U-shaped fluid channels 27.

The aforementioned conventional heat dissipating devices are disadvantageous in that the working fluid tends to be unevenly distributed in the planar housing. In addition, since boundary layers that develop at walls of the upper and lower ribs 14, 26 are continuous along the lengths of the upper and lower ribs 14, 26, the amount of heat carried by the working fluid in the planar housing is considerably reduced.

### SUMMARY OF THE INVENTION

Therefore, the object of the present invention is to provide a heat dissipating device that is capable of overcoming at least one of the aforesaid drawbacks associated with the prior art.

According to one aspect of the present invention, a heat dissipating device comprises: a planar housing defining a planar inner space therein; and a partitioning unit dividing the inner space into a plurality of upper fluid channels and a plurality of lower fluid channels that cross the upper fluid channels. Each of the upper fluid channels is in fluid communication with at least one of the lower fluid channels at an intersection therebetween.

According to another aspect of the present invention, a heat dissipating device comprises: a planar housing defining a planar inner space therein; and a partitioning unit including an array of rib members that divide at least a portion of the inner space into a network of interconnected fluid channels.

### BRIEF DESCRIPTION OF THE DRAWINGS

In drawings which illustrate embodiments of the invention,

FIG. 1 is a schematic view of a conventional planar heat dissipating device together with a cooling unit for dissipating heat from an electronic component;

FIG. 2 is an exploded perspective view of the conventional planar heat dissipating device;

FIG. 3 is an exploded perspective view of another conventional planar heat dissipating device;

FIG. 4 is a schematic view of the first preferred embodiment of a planar heat dissipating device according to this invention;

FIG. 5 is a perspective view to illustrate the structure of an assembly of an upper housing half and an upper portion of a partitioning unit of the first preferred embodiment;

FIG. 6 is a perspective view to illustrate the structure of an assembly of a lower housing half and a lower portion of the partitioning unit of the first preferred embodiment;

FIG. 7 is a fragmentary enlarged perspective view to illustrate the structure of upper and lower flow channels in an inner space divided by the partitioning unit of the first preferred embodiment;

FIG. 8 is an exploded perspective view of the second preferred embodiment of the planar heat dissipating device according to this invention;

FIG. 9 is a fragmentary enlarged perspective view to illustrate the structure of an assembly of first and second middle layers of ribs of the partitioning unit of the second preferred embodiment;

FIG. 10 is an exploded perspective view of the third preferred embodiment of the planar heat dissipating device according to this invention;

FIG. 11 is a fragmentary enlarged schematic view to illustrate the structure of a partitioning unit of the third preferred embodiment;

FIG. 12 is a schematic view illustrating how a fluid flows in channels defined by an assembly of ribs of the third preferred embodiment;

FIG. 13 is an exploded perspective view of the fourth preferred embodiment of the planar heat dissipating device according to this invention;

FIG. 14 is a fragmentary enlarged perspective view of an assembly of a lower housing half and a lower portion of the partitioning unit of the fourth preferred embodiment; and

FIG. 15 is a schematic view illustrating how a fluid flows in channels defined by an assembly of ribs of the fourth preferred embodiment.

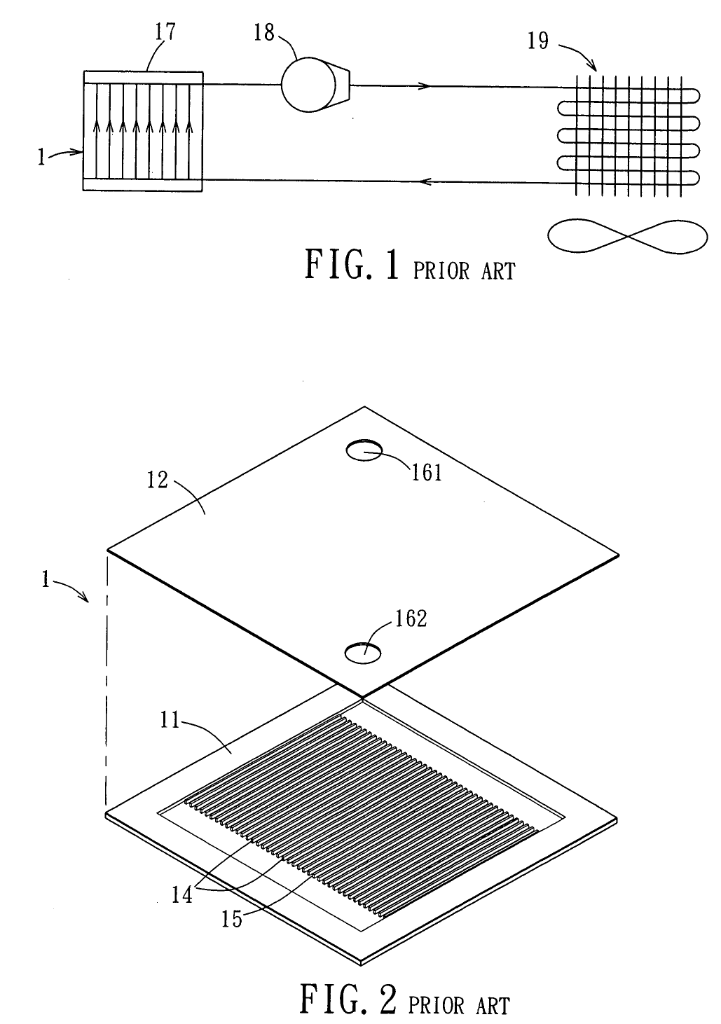

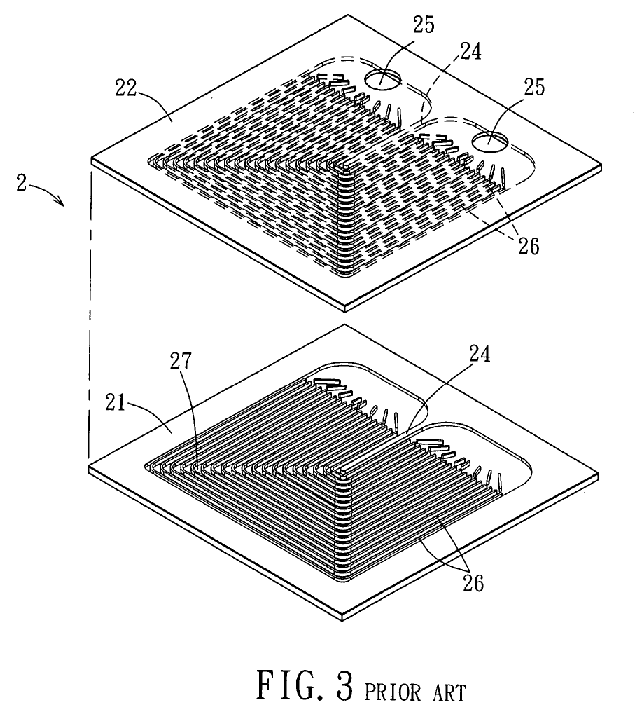

### DETAILED DESCRIPTION OF THE PREFERRED EMBODIMENTS

For the sake of brevity, like elements are denoted by the same reference numerals throughout the disclosure.

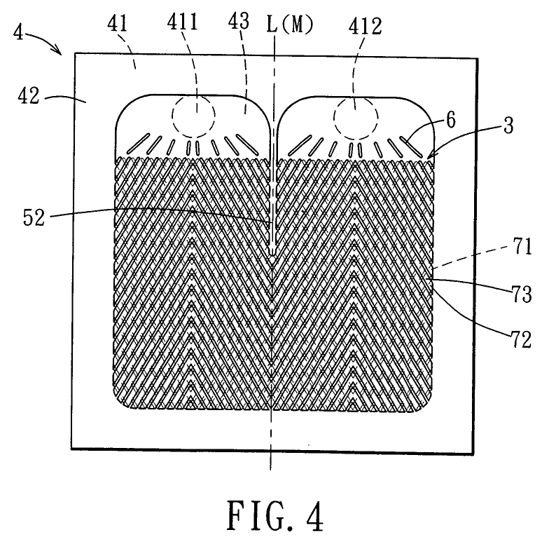

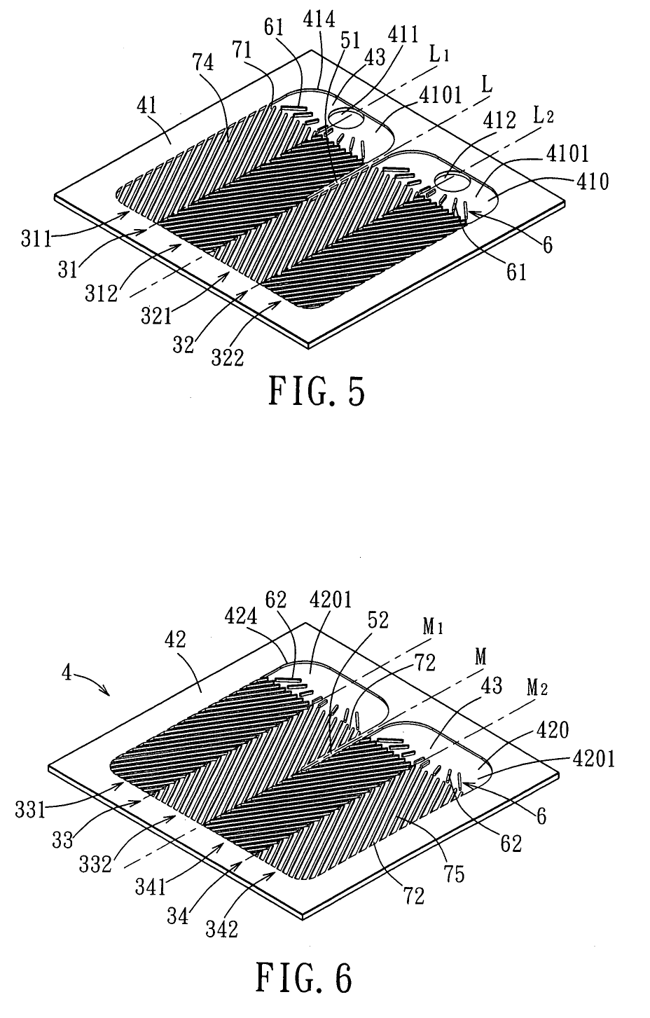

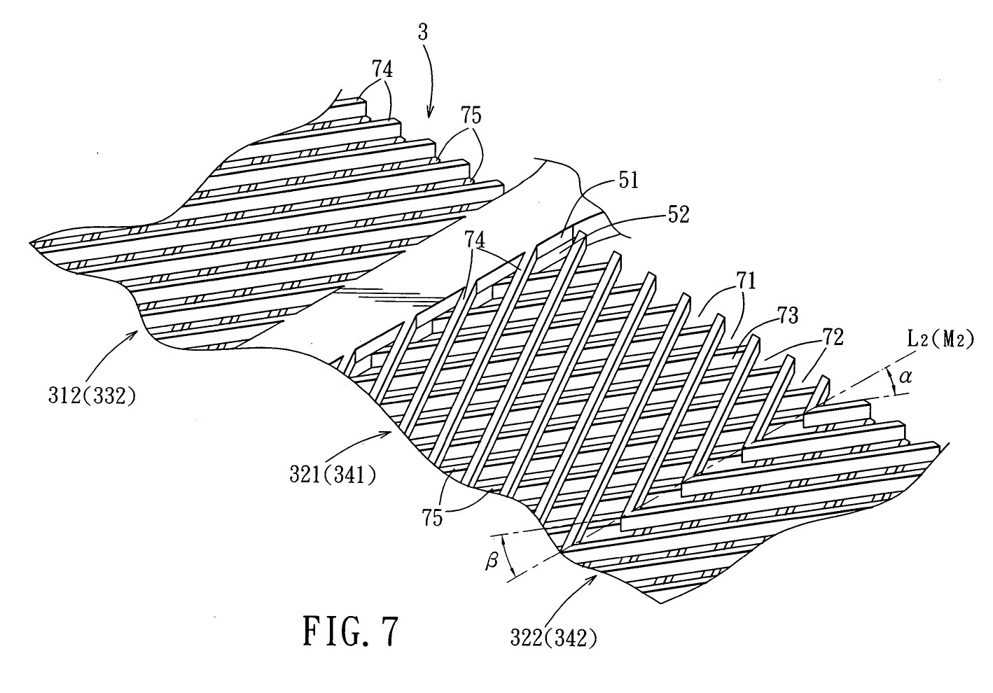

FIGS. 4 to 7 illustrate the first preferred embodiment of a planar heat dissipating device according to this invention for dissipating heat from an electronic component, such as a central processing unit.

The planar heat dissipating device includes: a planar housing 4 defining a planar inner space 43 therein; and a partitioning unit 3 dividing the inner space 43 into a plurality of upper fluid channels 71 and a plurality of lower fluid channels 72 that cross the upper fluid channels 71. Each of the upper fluid channels 71 is in fluid communication with at least one of the lower fluid channels 72 at an intersection 73 therebetween in a normal direction relative to the planar housing 4.

In this embodiment, the partitioning unit 3 includes an upper layer of a plurality of first ribs 74 that cooperatively define the upper fluid channels 71, and a lower layer of a plurality of second ribs 75 that cooperatively define the lower fluid channels 72. The upper and lower layers are formed into a stack.

The first ribs 74 are grouped into first and second columns 31, 32 that are line symmetrical and that cooperatively define a first central line (L) of symmetry. The second ribs 75 are grouped into third and fourth columns 33, 34 that are line symmetrical and that cooperatively define a second central line (M) of symmetry which coincides with the first central line (L) of symmetry.

The first ribs 74 of each of the first and second columns 31, 32 are grouped into two sub-columns 311, 312 (321, 322) that are line symmetrical and that cooperatively define a first line L₁ (L₂) of symmetry which is parallel to the first central line (L) of symmetry. The second ribs 75 of each of the third and fourth columns 33, 34 are grouped into two sub-columns 331, 332 (341, 342) that are line symmetrical and that cooperatively define a second line M₁ (M₂) of symmetry which coincides with the first line L₁ (L₂) of symmetry of a respective one of the first and second columns 31, 32.

The first ribs 74 of each of the sub-columns 311, 312 (321, 322) of each of the first and second columns 31, 32 are parallel to each other and are oblique relative to the first line L₁ (L₂) of symmetry. The second ribs 75 of each of the sub-columns 331, 332 (341, 342) of each of the third and fourth columns 33, 34 are parallel to each other, are oblique relative to the second line M₁ (M₂) of symmetry, and cross the first ribs 74 of a respective one of the sub-columns 311, 312 (321, 322) of a respective one of the first and second columns 31, 32.

Each of the first ribs 74 of each of the sub-columns 311, 312 (321, 322) of each of the first and second columns 31, 32 defines a first acute angle α with the first line L₁ (L₂) of symmetry. Each of the second ribs 75 of each of the sub-columns 331, 332 (341, 342) of each of the third and fourth columns 33, 34 defines a second acute angle β with the second line M₁ (M₂) of symmetry. The first and second angles α, β are the same. Preferably, the first and second acute angles α, β range from 15 to 60 degrees.

Each of the sub-columns 311, 312 (321, 322) of each of the first and second columns 31, 32 is generally rectangular in shape, and has a side that coincides with the first line L₁ (L₂) of symmetry of a respective one of the first and second columns 31, 32. Each of the sub-columns 331, 332 (341, 342) of each of the third and fourth columns 33, 34 is generally rectangular in shape, and has a side that coincides with the second line M₁ (M₂) of symmetry of a respective one of the third and fourth columns 33, 34.

The planar housing 4 includes a rectangular upper housing half 41 that is formed with a rectangular first recess 410 defined by a first recess-defining wall 414 and divided into two first regions 4101 by the first central line (L) of symmetry, and a rectangular lower housing half 42 that is defined by a second recess-defining wall 424, that complements the upper housing half 41, and that is formed with a rectangular second recess 420 divided into two second regions 4201 by the second central line (M) of symmetry. The first and second recesses 410, 420 cooperatively define the planar inner space 43. The first ribs 74 of the first column 31 protrude in the normal direction from the upper housing half 41 into one of the first regions 4101 of the first recess 410. The first ribs 74 of the second column 32 protrude in the normal direction from the upper housing half 41 into the other of the first regions 4101 of the first recess 410. The second ribs 75 of the third column 33 protrude in the normal direction from the lower housing half 42 into one of the second regions 4201 of the second recess 420. The second ribs 75 of the fourth column 34 protrude in the normal direction from the lower housing half 42 into the other of the second regions 4201 of the second recess 420. The upper housing half 41 is formed with a fluid inlet 411 in fluid communication with one of the first regions 4101 of the first recess 410, and a fluid outlet 412 in fluid communication with the other of the first regions 4101 of the first recess 410.

The partitioning unit 3 further includes a first central rib 51 extending from the first recess-defining wall 414 of the upper housing half 41 along the first central line (L) of symmetry and connected to a portion of the first ribs 74 of an adjacent one of the sub-columns 312 of the first column 31 and to a portion of the first ribs 74 of an adjacent one of the sub-columns 321 of the second column 32, and a second central rib 52 extending from the second recess-defining wall 424 of the lower housing half 42 along the second central line (M) of symmetry and connected to a portion of the second ribs 75 of an adjacent one of the sub-columns 332 of the third column 33 and to a portion of the second ribs 75 of an adjacent one of the sub-columns 341 of the fourth column 34.

A fluid distributing unit 6 is provided in the inner space 43 in the planar housing 4, and includes a plurality of first distributing ribs 61 protruding from the upper housing half 41 into the first recess 410, and a plurality of second distributing ribs 62 protruding from the lower housing half 42 into the second recess 420. A portion of the first distributing ribs 61 is disposed between the fluid inlet 411 and the first column 31 of the first ribs 74, and the remainder of the first distributing ribs 61 is disposed between the fluid outlet 412 and the second column 32 of the first ribs 74. Each of the second distributing ribs 62 is aligned with and is stacked on a respective one of the first distributing ribs 61.

In this embodiment, the planar housing 4 has a size of 50 mm×50 mm×2 mm, each of the first and second ribs 74, 75 has a height of 0.4 mm, and the width between two adjacent ones of the first ribs 74 of each of the sub-columns 311, 312 (321, 322) of each of the first and second columns 31, 32 or the second ribs 75 of each of the sub-columns 331, 332 (341, 342) of each of the third and fourth columns 33, 34 is 0.7 mm. Preferably, the planar housing 4 has a length ranging from 20 to 70 mm, a width ranging from 20 to 70 mm, and a height ranging from 0.5 to 5 mm, each of the first and second ribs 74, 75 has a height ranging from 0.1 to 4 mm, and the width between two adjacent ones of the first ribs 74 of each of the sub-columns 311, 312 (321, 322) of each of the first and second columns 31, 32 or the second ribs 75 of each of the sub-columns 331, 332 (341, 342) of each of the third and fourth columns 33, 34 ranges from 0.1 to 2 mm.

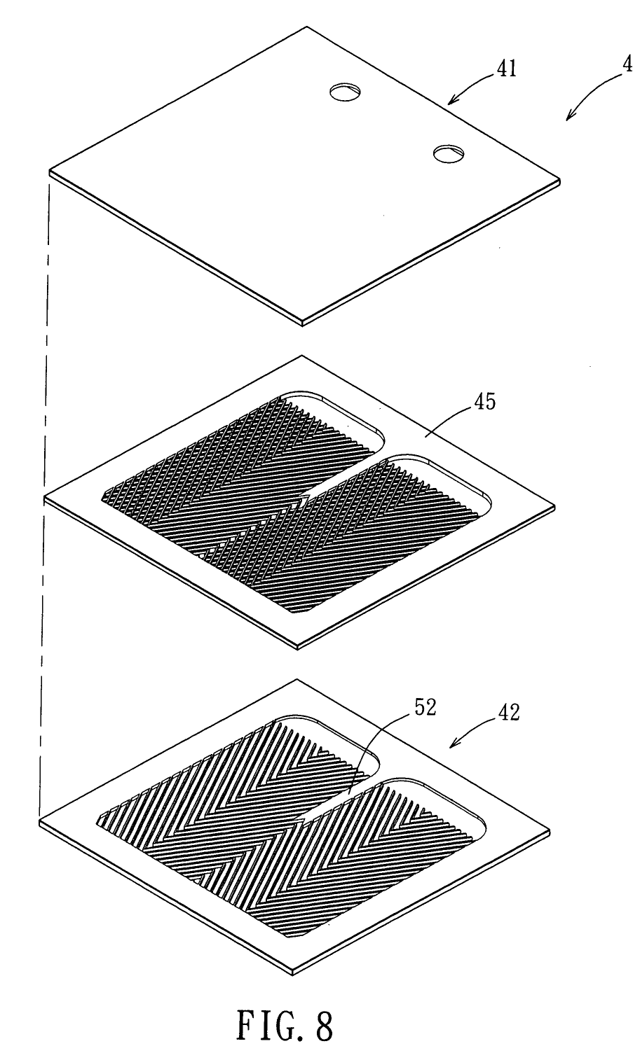

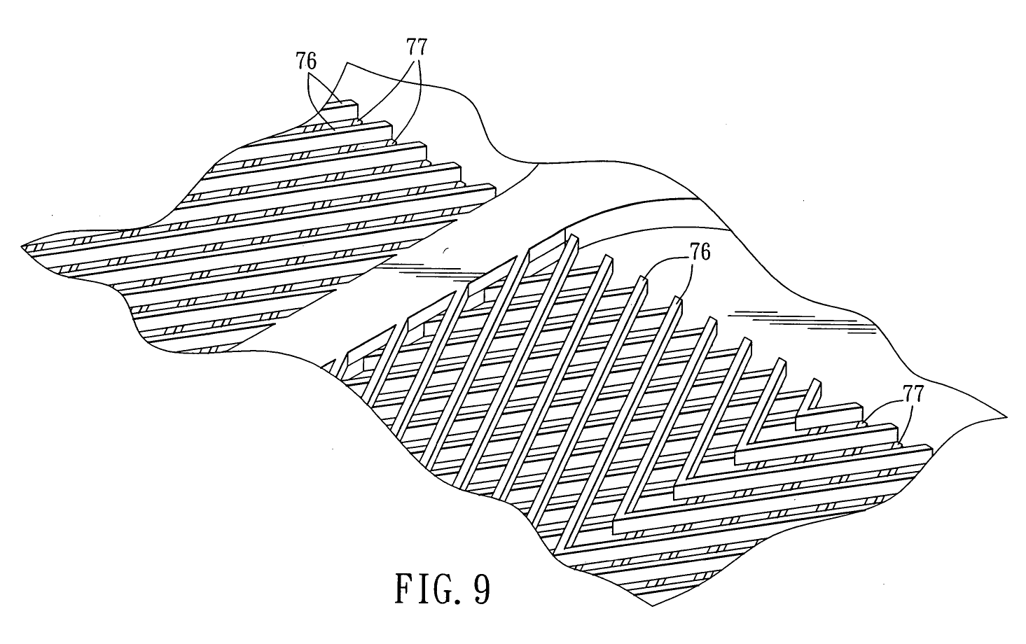

FIGS. 8 and 9 illustrate the second preferred embodiment of the planar heat dissipating device according to this invention. The planar heat dissipating device of this embodiment differs from the previous embodiment in that the partitioning unit 3 further includes a first middle layer of a plurality of third ribs 76 and a second middle layer of a plurality of fourth ribs 77. The upper layer of the first ribs 74, the first middle layer of the third ribs 76, the second middle layer of the fourth ribs 77, and the lower layer of the second ribs 75 are stacked in this order. The first middle layer of the third ribs 76 has a structure the same as that of the lower layer of the second ribs 75, while the second middle layer of the fourth ribs 77 has a structure the same as that of the upper layer of the first ribs 74. Alternatively, the stack may be modified into a three layer structure, a five layer structure, etc.

In this embodiment, the first middle layer of the third ribs 76 and the second middle layer of the fourth ribs 77 are disposed in and are connected to an inner wall of a frame 45. Alternatively, the frame 45 may be dispensed with.

With the inclusion of the upper layer of the first ribs 74 and the lower layer of the second ribs 75 in the heat dissipating device of this invention, uniform flow distribution in the inner space 43 in the planar housing 4 can be achieved, thereby eliminating the aforesaid uneven flow distribution drawback associated with the prior art.

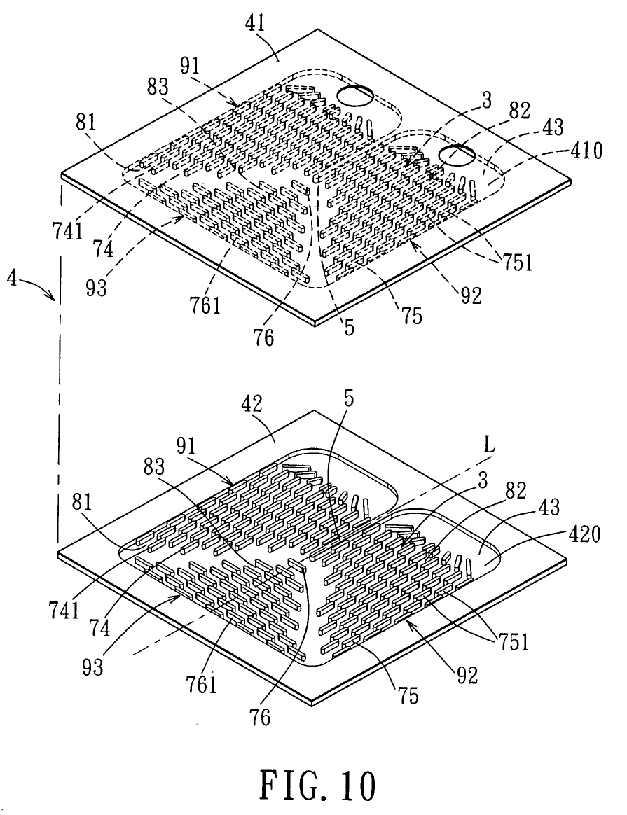

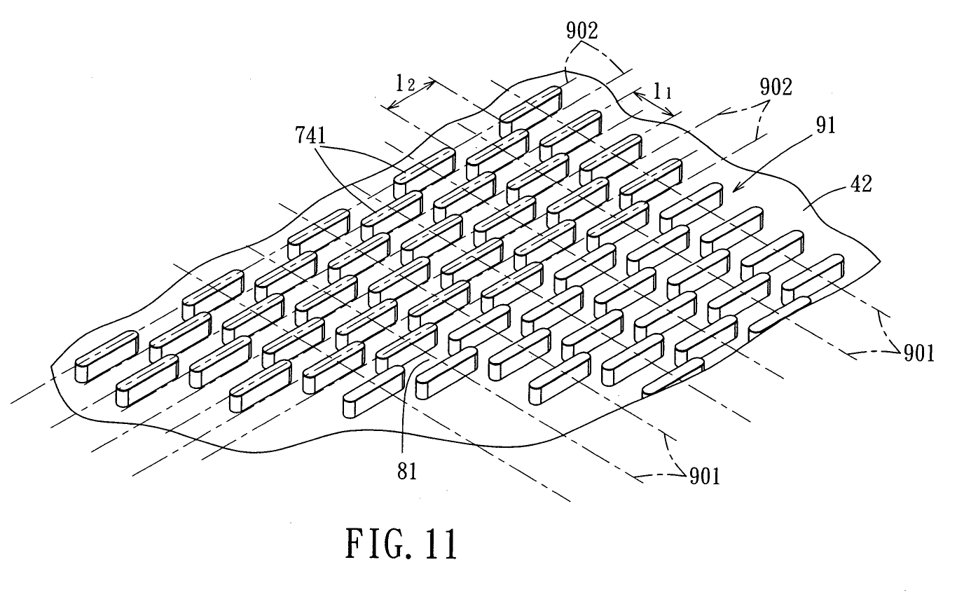

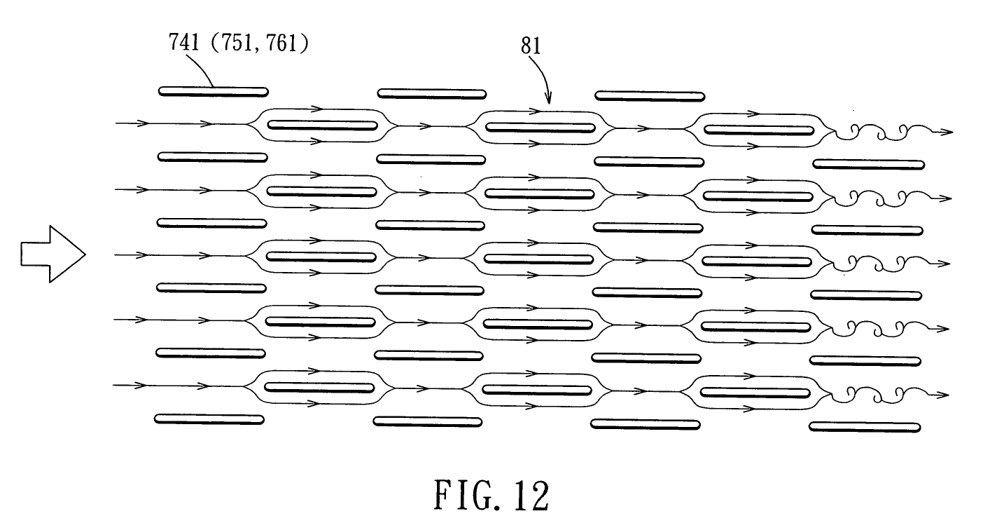

FIGS. 10 and 11 illustrate the third preferred embodiment of the planar heat dissipating device according to this invention. The planar heat dissipating device of this embodiment includes: a planar housing 4 defining a planar inner space 43 therein; and a partitioning unit 3 including a first array 91 of first rib members 74 that divide at least a portion of the inner space 43 into a first network 81 of interconnected fluid channels (see FIG. 12).

In this embodiment, the first array 91 of the first rib members 74 is divided into rows 901 and columns 902 of the first rib members 74. The first rib members 74 of two adjacent ones of the rows 901 are arranged in a staggered manner. The first rib members 74 of two adjacent ones of the columns 902 are arranged in a staggered manner. Two adjacent ones of the first ribs 74 of each of the rows 901 are spaced apart from each other by a first distance (l₁). Two adjacent ones of the first ribs 74 of each of the columns 902 are spaced apart from each other by a second distance (l₂).

The planar housing 4 includes an upper housing half 41 that is formed with a first recess 410, and a lower housing half 42 that complements the upper housing half 41 and that is formed with a second recess 420. Each of the first rib members 74 includes a pair of upper and lower ribs 741 that protrude from the upper and lower housing halves 41, 42 into the first and second recesses 410, 420, respectively, in a normal direction relative to the planar housing 4.

The partitioning unit 3 further includes a second array 92 of second rib members 75 that divide another portion of the inner space 43 into a second network 82 of interconnected fluid channels. Each of the second rib members 75 includes a pair of upper and lower ribs 751 that protrude from the upper and lower housing halves 41, 42 into the first and second recesses 410, 420, respectively, in the normal direction relative to the planar housing 4. The first array 91 of the first rib members 74 and the second array 92 of the second rib members 75 are line symmetrical and cooperatively define a central line (L) of symmetry.

The partitioning unit 3 further includes a third array 93 of third rib members 76 that divide the remainder of the inner space 43 into a third network 83 of interconnected fluid channels. Each of the third rib members 76 includes a pair of upper and lower ribs 761 that protrude from the upper and lower housing halves 41, 42 into the first and second recesses 410, 420, respectively, in the normal direction relative to the planar housing 4. The third network 83 interconnects the first network 81 and the second network 82.

The partitioning unit 3 further includes a central rib member 5 extending from the planar housing 4 along the central line (L) of symmetry, and connected to adjacent ones of the first rib members 74 and adjacent ones of the second rib members 75.

Each of the upper and lower ribs 741 of the first rib members 74, the upper and lower ribs 751 of the second rib members 75, and the upper and lower ribs 761 of the third rib members 76 has a height ranging from 0.1 to 4 mm, and a width ranging from 0.1 to 1 mm. The width between two adjacent ones of the upper or lower ribs 741 (751, 761) ranges from 0.5 to 4 mm. Preferably, the length of each of the upper and lower ribs 741 (751, 761) is 2 to 15 times of the width thereof, and preferably the width between two adjacent ones of the upper or lower ribs 741 (751, 761) is one to 3 times of the length of each of the upper and lower ribs 741 (751, 761).

Since the upper and lower ribs 741 (751, 761) are discrete, the continuity of the boundary layer of the fluid flowing in the inner space 43 of the planar housing 4 is destroyed, thereby alleviating the adverse effect on the heat dissipating efficiency attributed to the boundary layer as encountered in the prior art. Moreover, as best illustrated in FIG. 12, the fluid flow in each fluid channel is divided into two streams, each of which is mingled with an adjacent stream of an adjacent one of the fluid channels due to the staggered arrangement of the first, second and third rib members 74, 75 76.

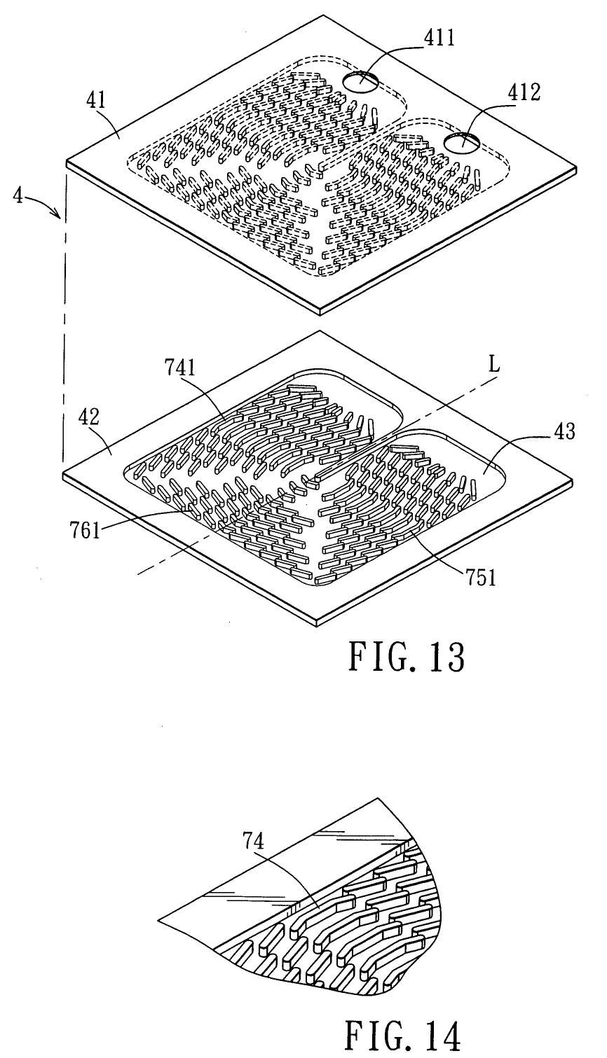

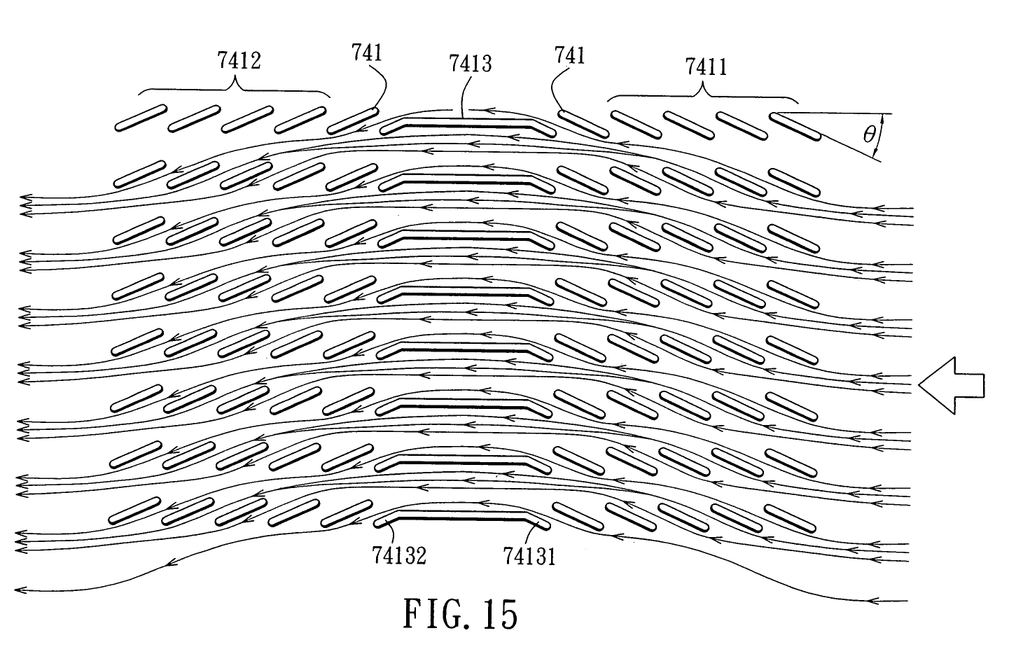

FIGS. 13 and 14 illustrate the fourth preferred embodiment of the planar heat dissipating device according to this invention. The heat dissipating device of this preferred embodiment differs from the third preferred embodiment in the arrangements of the first, second and third rib members 74, 75, 76. Since the arrangements of the first, second and third rib members 74, 75, 76 are similar, only the arrangement of upper ribs 741 of the first rib members 74 is described herein. As illustrated in FIG. 15, the upper ribs 741 are divided into rows of parallel first short ribs 7411, rows of parallel second short ribs 7412, and one row of parallel long ribs 7413 disposed between an adjacent row of the first short ribs 7411 and an adjacent row of the second short ribs 7412. Each of the first short ribs 7411 is straight, and forms an angle θ with the central line (L) of symmetry (see FIGS. 13 and 15). The first and second short ribs 7411, 7412 have the same structure, and are arranged in a line symmetrical manner. Each of the long ribs 7413 has first and second end portions 74131, 74132 and a straight middle portion extending between the first and second end portions 74131, 74132. The first end portion 74131 of each of the long ribs 7413 is parallel to and is disposed between two adjacent ones of the first short ribs 7411. The second end portion 74132 of each of the long ribs 7413 is parallel to and is disposed between two adjacent ones of the second short ribs 7412. Preferably, the angle ranges from 15 to 45 degrees so as to achieve a better heat dissipating efficiency.

The arrangement of the first and second short ribs 7411, 7412 and the long ribs 7413 permit control of fluid flow to travel in a tortuous and controlled manner (see FIG. 15) and repeated dividing and mingling of fluid flows along the path from the fluid inlet 511 to the fluid outlet 412, thereby promoting uniform distribution of the fluid in the inner space 43 of the planar housing 4.

With the invention thus explained, it is apparent that various modifications and variations can be made without departing from the spirit of the present invention. It is therefore intended that the invention be limited only as recited in the appended claims.

What is claimed is:

1. A planar heat dissipating device comprising:
a planar housing defining a planar inner space therein; and
a partitioning unit dividing said inner space into a plurality of upper fluid channels and a plurality of lower fluid channels that cross said upper fluid channels, each of said upper fluid channels being in fluid communication with at least one of said lower fluid channels at an intersection therebetween.

2. The planar heat dissipating device of claim 1, wherein each of said upper fluid channels is in fluid communication with said at least one of said lower fluid channels at said intersection therebetween in a normal direction relative to said planar housing.

3. The planar heat dissipating device of claim 2, wherein said partitioning unit includes an upper layer of a plurality of first ribs that cooperatively define said upper fluid channels, and a lower layer of a plurality of second ribs that cooperatively define said lower fluid channels, said upper and lower layers being formed into a stack.

4. The planar heat dissipating device of claim 3, wherein said first ribs are grouped into first and second columns that are line symmetrical and that cooperatively define a first central line of symmetry, said second ribs being grouped into third and fourth columns that are line symmetrical and that cooperatively define a second central line of symmetry which coincides with said first central line of symmetry.

5. The planar heat dissipating device of claim 4, wherein said first ribs of each of said first and second columns are grouped into two sub-columns that are line symmetrical and that cooperatively define a first line of symmetry which is parallel to said first central line of symmetry, said second ribs of each of said third and fourth columns being grouped into two sub-columns that are line symmetrical and that cooperatively define a second line of symmetry which coincides with said first line of symmetry of a respective one of said first and second columns.

6. The planar heat dissipating device of claim 5, wherein said first ribs of each of said sub-columns of each of said first and second columns are parallel to each other and are oblique relative to said first line of symmetry, said second ribs of each of said sub-columns of each of said third and fourth columns being parallel to each other, being oblique relative to said second line of symmetry, and crossing said first ribs of a respective one of said sub-columns of a respective one of said first and second columns.

7. The planar heat dissipating device of claim 6, wherein each of said first ribs of each of said sub-columns of each of said first and second columns defines a first acute angle with said first line of symmetry, each of said second ribs of each of said sub-columns of each of said third and fourth columns defining a second acute angle with said second line of symmetry, said first and second acute angles being the same.

8. The planar heat dissipating device of claim 7, wherein said first acute angle ranges from 15 to 60 degrees.

9. The planar heat dissipating device of claim 7, wherein each of said sub-columns of each of said first and second columns is generally rectangular in shape and has a side that coincides with said first line of symmetry of a respective one of said first and second columns, each of said sub-columns of each of said third and fourth columns being generally rectangular in shape and having a side that coincides with said second line of symmetry of a respective one of said third and fourth columns.

10. The planar heat dissipating device of claim 7, wherein said planar housing includes an upper housing half that is formed with a first recess divided into two first regions by said first central line of symmetry, and a lower housing half that complements said upper housing half and that is formed with a second recess divided into two second regions by said second central line of symmetry, said first ribs of said first column protruding in said normal direction from said upper housing half into one of said first regions of said first recess, said first ribs of said second column protruding in said normal direction from said upper housing half into the other of said first regions of said first recess, said second ribs of said third column protruding in said normal direction from said lower housing half into one of said second regions of said second recess, said second ribs of said fourth column protruding in said normal direction from said lower housing half into the other of said second regions of said second recess.

11. The planar heat dissipating device of claim 10, wherein said partitioning unit further includes a first central rib extending from said upper housing half along said first central line of symmetry and connected to a portion of said first ribs of an adjacent one of said sub-columns of said first column and to a portion of said first ribs of an adjacent one of said sub-columns of said second column, and a second central rib extending from said lower housing half along said second central line of symmetry and connected to a portion of said second ribs of an adjacent one of said sub-columns of said third column and to a portion of said second ribs of an adjacent one of said sub-columns of said fourth column.

12. The planar heat dissipating device of claim 7, wherein said partitioning unit further includes a first middle layer of a plurality of third ribs and a second middle layer of a plurality of fourth ribs, said upper layer of said first ribs, said first middle layer of said third ribs, said second middle layer of said fourth ribs, and said lower layer of said second ribs being stacked in this order.

13. The planar heat dissipating device of claim 12, wherein said first middle layer of said third ribs has a structure the same as that of said lower layer of said second ribs, said second middle layer of said fourth ribs having a structure the same as that of said upper layer of said first ribs.

14. A planar heat dissipating device comprising:
a planar housing defining a planar inner space therein; and
a partitioning unit including a first array of first rib members that divide at least a portion of said inner space into a first network of interconnected fluid channels.

15. The planar heat dissipating device of claim 14, wherein said first array of said first rib members is divided into rows and columns of said first rib members, said first rib members of two adjacent ones of said rows being arranged in a staggered manner, said first rib members of two adjacent ones of said columns being arranged in a staggered manner, two adjacent ones of said first rib members of each of said rows being spaced apart from each other by a first distance, two adjacent ones of said first rib members of each of said columns being spaced apart from each other by a second distance.

16. The planar heat dissipating device of claim 15, wherein said planar housing includes an upper housing half that is formed with a first recess, and a lower housing half that complements said upper housing half and that is formed with a second recess, each of said first rib members including a pair of upper and lower ribs that protrude from said upper and lower housing halves into said first and second recesses, respectively, in a normal direction relative to said planar housing.

17. The planar heat dissipating device of claim 16, wherein said partitioning unit further includes a second array of second rib members that divide another portion of said inner space into a second network of interconnected fluid channels, said first array of said first rib members and said second array of said second rib members being line symmetrical and cooperatively defining a central line of symmetry.

18. The planar heat dissipating device of claim 17, wherein said partitioning unit further includes a third array of third rib members that divide the remainder of said inner space into a third network of interconnected fluid channels, said third network interconnecting said first and second networks.

19. The planar heat dissipating device of claim 18, wherein said partitioning unit further includes a central rib member extending from said planar housing along said central line of symmetry, and connected to adjacent ones of said first rib members and adjacent ones of said second rib members.

20. The planar heat dissipating device of claim 18, wherein said upper ribs of said first rib members are divided into rows of parallel first short ribs, rows of parallel second short ribs, and one row of parallel long ribs disposed between an adjacent row of said first short ribs and an adjacent row of said second short ribs, each of said first short ribs forming an angle with said central line of symmetry, said angle ranging from 15 to 45 degrees, said first short ribs and said second short ribs being arranged in a line symmetrical manner, each of said long ribs having bent first and second end portions, said first end portion of each of said lone ribs being parallel to said first short ribs, said second end portion of each of said long ribs being parallel to said second short ribs.
